(19) United States
(12) Patent Application Publication
(10) Pub. No.: US 2019/0010702 A1
(43) Pub. Date: Jan. 10, 2019

(54) METAL LAMINATE BASE SHEET FOR USE WITH MASONRY STRUCTURE

(71) Applicant: Robert Lloyd, Greenville, TX (US)

(72) Inventor: Robert Lloyd, Greenville, TX (US)

(21) Appl. No.: 15/875,374

(22) Filed: Jan. 19, 2018

Related U.S. Application Data
(60) Provisional application No. 62/528,860, filed on Jul. 5, 2017.

(51) Int. Cl. E04D 11/02; E04B 7/22; E04D 7/00

(52) U.S. Cl. CPC E04D 11/02; Y02B 80/34; E04D 7/00; E04B 7/22

(57) ABSTRACT

A structure includes: a stone layer; and a laminate of a metal layer and a fabric overlying stone layer such that the metal layer faces the stone layer. The metal layer has embossments thereon forming venting channels.

The present application claims priority from U.S. Provisional Application No. 62/528,860 filed Jul. 5, 2017, the entire disclosure of which is incorporated herein by reference.

### BACKGROUND

The present invention generally deals with systems and methods for building a thermally insulated stone structure. The present invention includes the subject matter disclosed in U.S. Pat. No. 5,884,446.

Built-up roofs are formed of alternate layers of bituminous material and felt which are assembled or “built-up” in the field. The alternate layers of bituminous material and felt are assembled onto an overlay which overlies an insulation layer. The insulation layer and overlay are attached to a roof deck which typically is made of metal, wood, concrete gypsum or any other conventional deck material. A conventional built-up roof is described in U.S. Pat. No. 5,884,446.

The term “built-up roof composite” as used herein means any one of a plurality of different conventional built-up roof composites used on the top of overlays, such as the built-up roof composite described herein, as well as others, such as EPDM, PVC, modified bitumen, coal tar and Hypolon. The bituminous material is usually of coal tar or asphalt origin and is applied by hot-mopping between alternate layers of the felt.

U.S. Pat. No. 5,884,446 describes the use of a metal layer as a fire barrier to prevent bitumen entering the underlying building and fueling a fire. Additionally, the metal layer acts as a barrier for preventing any bitumen (or other material) applied during installation from penetrating the deck and into the interior of the underlying building. Additionally, the metal layer, in the case of wood decks, prevents the roof from being adhesively attached to the deck since such adhesion could make roof replacement very costly and, in some cases, impossible. The relativeness thinness of the fabric/metal laminate, as compared to the half-inch fiber board, also results in the sizing down of the height of the peripheral edges of the roof, thereby requiring less labor and material in providing edge detailing.

U.S. Pat. No. 5,884,446 merely describes the use of a metal laminate base sheet for use on a wooden roof.

There exists a need to reduce the thermal energy transfer through a masonry structure.

### SUMMARY

The present invention provides a system of method to reduce the thermal energy transfer through a masonry structure.

Various embodiments described herein are drawn to a structure including: a stone layer; and a laminate of a metal layer and a fabric overlying a masonry layer such that the metal layer faces the masonry layer. The metal layer may have embossments thereon forming venting channels.

### BRIEF SUMMARY OF THE DRAWINGS

The accompanying drawings, which are incorporated in and form a part of the specification, illustrate an exemplary embodiment of the present invention and, together with the description, serve to explain the principles of the invention. In the drawings:

FIG. 1 illustrates a cross-sectional view of a prior art metal laminate base sheet;

FIG. 2 illustrates a cross-sectional view of another prior art metal laminate base sheet;

FIG. 3 illustrates a cross-sectional view of a masonry surface;

FIG. 4 illustrates a cross-sectional view of a masonry building;

FIG. 5 illustrates a cross-sectional view of a masonry surface with a metal laminate base sheet in accordance with aspects of the present invention;

FIG. 6 illustrates a cross-sectional view of a masonry building with a metal laminate base sheet in accordance with aspects of the present invention;

FIG. 7 illustrates a dual-marked metal laminate base sheet in accordance with aspects of the present invention;

FIG. 8A illustrates a masonry surface of a residential building;

FIG. 8B illustrates the masonry surface of FIG. 8A, with the dual-marked based sheet of FIG. 7 disposed thereon in accordance with aspects of the present invention;

FIG. 8C illustrates the masonry surface of FIG. 8A, with another metal laminate base sheet disposed thereon in accordance with aspects of the present invention;

FIG. 9A illustrates a masonry surface of a commercial building;

FIG. 9B illustrates the masonry surface of FIG. 9A, with the dual-marked based sheet of FIG. 7 disposed thereon in accordance with aspects of the present invention; and

FIG. 9C illustrates the masonry surface of FIG. 9A, with another metal laminate base sheet disposed thereon in accordance with aspects of the present invention.

### DETAILED DESCRIPTION

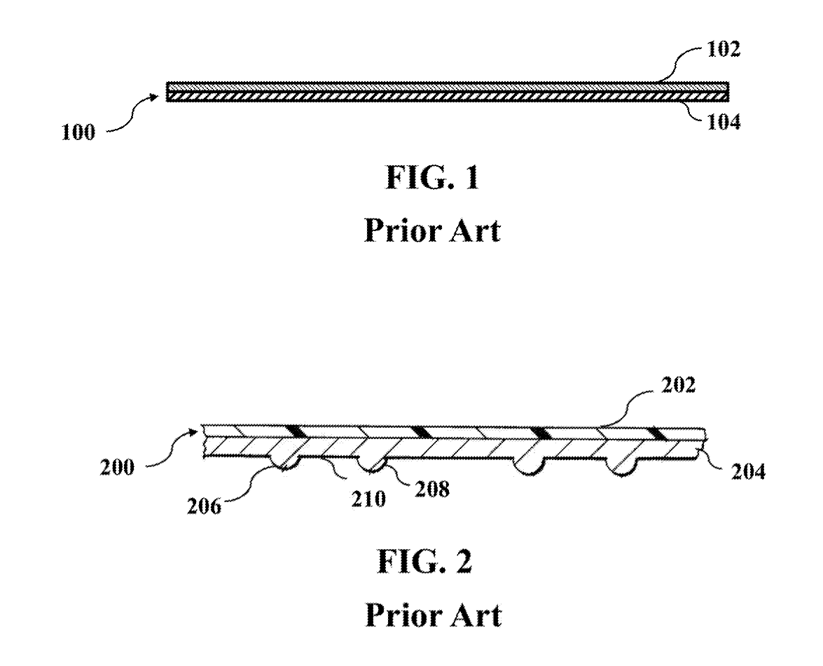

Non-limiting examples of prior art metal laminate base sheets will now be described with reference to FIGS. 1-2.

FIG. 1 illustrates a cross-sectional view of a prior art metal laminate base sheet 100.

As shown in the figure, metal laminate base sheet 100 includes a fabric 102 and a metal laminate layer 104. Metal laminate layer 104 may be aluminum and may be I mil thick and fabric 102 may be a non-woven polyester having a weight ranging from 4 to 14 ounces per square yard. A polyester sheet having satisfactory properties is one made by the Hoechst Celanese Company, New Jersey and sold under the trade name of Trivera®. The term “metal laminate and a fabric” as used herein includes two such layers which are either laid one on top of the other without bonding or are bonded to one another using well known metal/fabric bonding techniques.

Prior art metal laminate base sheet 100 is used in built-up roofs to prevent bituminous liquid entering the building through such seams and to act as a fire prevention layer. Particularly, it has been found that the seams at the high temperatures encountered in a building fire cause melting of the overlying polyester, which then enters the seam forming a fluid type seal between adjacent metal layers 104. This seal prevents any liquid bituminous material from passing through to any of the underlying layers. Thus, metal laminate base sheet 100 provides superior fire safety features.

FIG. 2 illustrates a cross-sectional view of another prior art metal laminate base sheet 200.

As shown in the figure, metal laminate base sheet 200 includes a fabric 202 and a metal laminate layer 204. Metal laminate layer 204 includes a plurality of embossments, a sample of which is indicated as embossments 206 and 208, disposed thereon. The plurality of embossments are disposed so as to create channels there between, a sample of which is indicated as channel 210.

The channels, such as channel 210, serve as vents for any moisture vapors that may be present. Such moisture vapors may result from normal conditions within the budding or from high humidity processes taking place within the building. In any event, moisture vapors which are not vented from a built-up roof can cause damage to insulation layers thereon and/or damage to the roof composite. Metal laminate base sheet 200, because metal laminate layer 204 serves as a vapor barrier, prevents any of the moisture vapors from reaching the overlying roof composite, while the channels, which are directed out to the edge of the roof, serve to vent out any moisture vapors and prevent the same from becoming trapped in the insulation and adversely affecting such insulation.

Metal laminate base sheet 200 may also find particular use in putting a new roof over an existing roof. When a roof has to be replaced, either the existing roof may be removed or a new roof placed over the old roof. Roofs that have to be replaced generally contain a substantial amount of residual moisture. Accordingly, placing a new roof over an existing roof requires means for venting the moisture which is retained in the old roof. This is efficaciously accomplished in accordance with the present invention by use of metal laminate base sheet 200, since the channels will enable venting of any moisture resulting from the old roof.

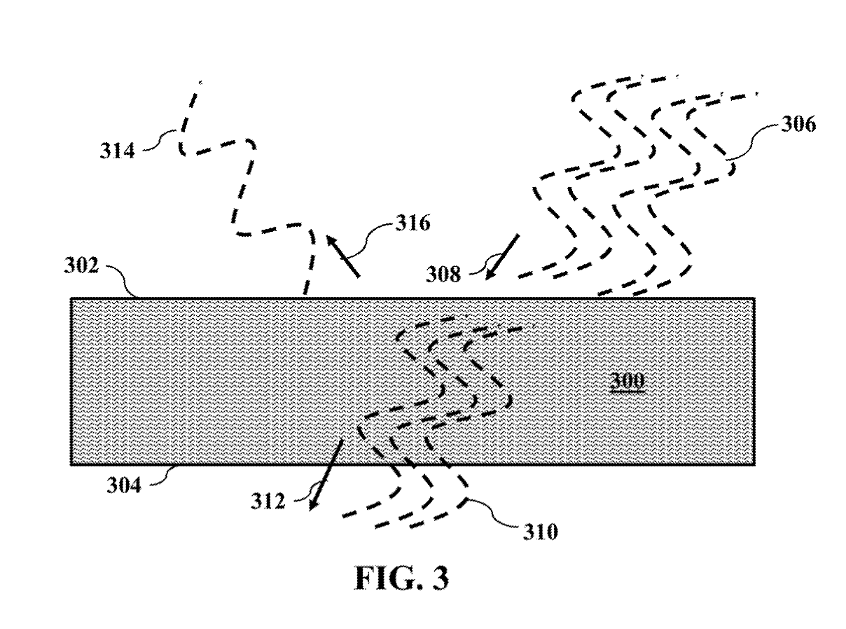

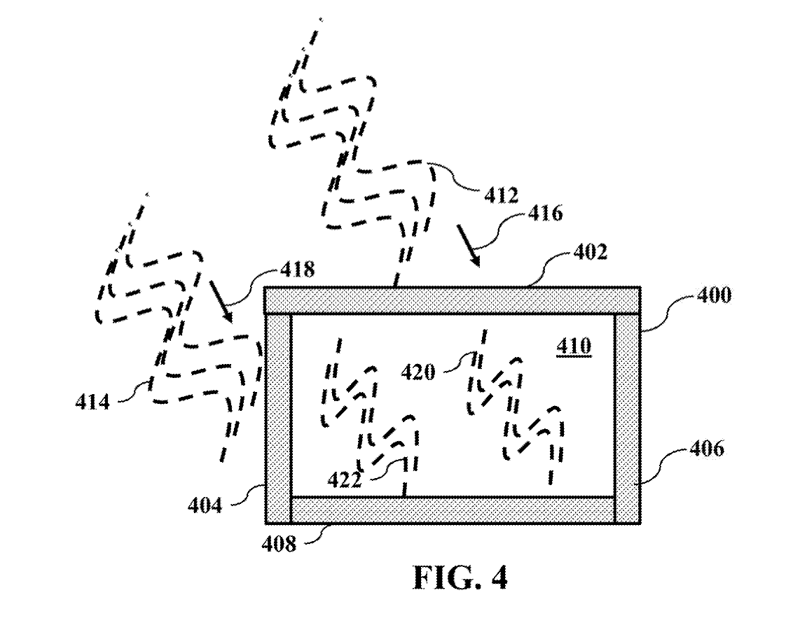

The effects of thermal energy transfer through masonry will now be described with reference to FIGS. 3-4.

FIG. 3 illustrates a cross-sectional view of a masonry surface 300. Masonry surface includes an exterior surface 302 exposed to radiant heat. from the sun and conductive heat from the ambient air and an interior surface 304.

As shown in the figure, thermal energy 306 is incident on exterior surface 302. For purposes of discussion, thermal energy 306 is illustrated as approaching exterior surface 302 in a direction indicated by vector 308. It should be noted that m actuality, thermal energy 306 is contacting exterior surface 302 from all directions above exterior surface 302.

Masonry surface 300 conducts a portion of thermal energy 306 such that portion of thermal energy 31.0 is transferred through masonry surface 300. For purposes of discussion, portion of thermal energy 310 is illustrated as passing through masonry surface 300 and through interior surface 304 in a direction indicated by vector 312. It should be noted that in actuality, portion of thermal energy 310 is radiating through masonry surface 300 in many directions.

Masonry surface 300 is able to reflect a portion of thermal energy 306 such that a portion of thermal energy 314 is reflected off exterior surface 302. For purposes of discussion, portion of thermal energy 314 is illustrated as reflecting from exterior surface 302 in a direction indicated by vector 316. It should be noted that in actuality, portion of thermal energy 314 is radiating away from exterior surface 302 in many directions.

Because of the amount of thermal energy that conducts through masonry surface 300, for example that represented by portion of thermal energy 310, a masonry structure heats up from energy provide from the sun or increased outdoor ambient air temperature. This will be described in greater detail with reference to FIG. 4.

FIG. 4 illustrates a cross-sectional view of a masonry building 400.

As shown in the figure, masonry building 400 includes a masonry roof 402, a masonry side 404, a masonry side 406 and a masonry floor 408. A front side and back side are not shown. The four walls, roof and floor surround an inner volume 410. It should be noted that any one of masonry roof 402, masonry side 404, masonry side 406 and masonry floor 408 may be any combination of layers of brick, mortar, stone, cement, concrete, block or associated meshings.

Similar to the discussion above with reference to FIG. 3, in the case of masonry building 400, thermal energy 412 is incident on masonry roof 402 and thermal energy 414 is incident on masonry side 404. For purposes of discussion, thermal energy 412 is illustrated as approaching masonry roof 402 in a direction indicated by vector 416 and thermal energy 414 is illustrated as approaching masonry side 404 in a direction indicated by vector 418. It should be noted that in actuality, thermal energy 412 is contacting masonry roof 402 from all directions above masonry roof 402 and thermal energy 414 is contacting masonry side 404 from all directions to the left of masonry side 404.

Similar to the discussion above with reference to FIG. 3, in the case of masonry building 400, a portion of thermal energy 412 conducts through masonry roof 402 as portion of thermal energy 320 within inner volume 410. Similarly, a portion of thermal energy 414 conducts through masonry side 404 as portion of thermal energy 422 within inner volume 410. Portion of thermal energy 414 and portion of thermal energy 422 increase the temperature of inner volume 410. In very hot climates, such an increase in temperature of a house, for example, is to be avoided.

Further, as nighttime arrives, the temperature of the air within inner volume 410 remains relatively high. However, the temperature of masonry roof 402, masonry side 404, masonry side 406 and masonry floor 408 start to cool. The difference in warm temperature of the air within inner volume 410 contacts the inner surfaces of the cooler masonry roof 402, masonry side 404, masonry side 406 and masonry floor 408, which creates condensation on the inner surfaces. This process is generally referred to as “sweating”. The condensation eventually evaporates into die air of inner volume 410 thereby increasing the humidity and decreasing the comfort.

An aspect of the invention is drawn to using the metal laminate base sheet to cover a masonry structure. A masonry structure is any structure including those of brick, mortar, stone, cement, concrete, block and combinations thereof The combination of the metal laminate base sheet with the masonry structure decreases the amount of thermal energy that is conducted into the inner volume of the masonry structure. The decrease in conducted thermal energy leads to a decrease in sweating of interior masonry surfaces. The decrease in sweating of the interior masonry surfaces leads to a decrease of humidity of the air within the inner volume of the masonry structure, which leads to more comfort.

It is clear that the combination of the metal laminate base sheet and the masonry surface greatly reduces heat transfer. As such, the metal laminate base sheet enables a much cooler stone housing structure.

In an example embodiment, the metal face is disposed on a fabric surface, wherein the white fabric is facing up upon installation. When installing on concrete, the white face may disposed on concrete on floors to be covered by hardwood or carpeting. In some embodiments wherein concrete walls are to be faced with stucco, a material in accordance with aspects of the present invention may be installed such that the fabric is facing out, wherein the metal side is attached to wall or concrete block or wallboard.

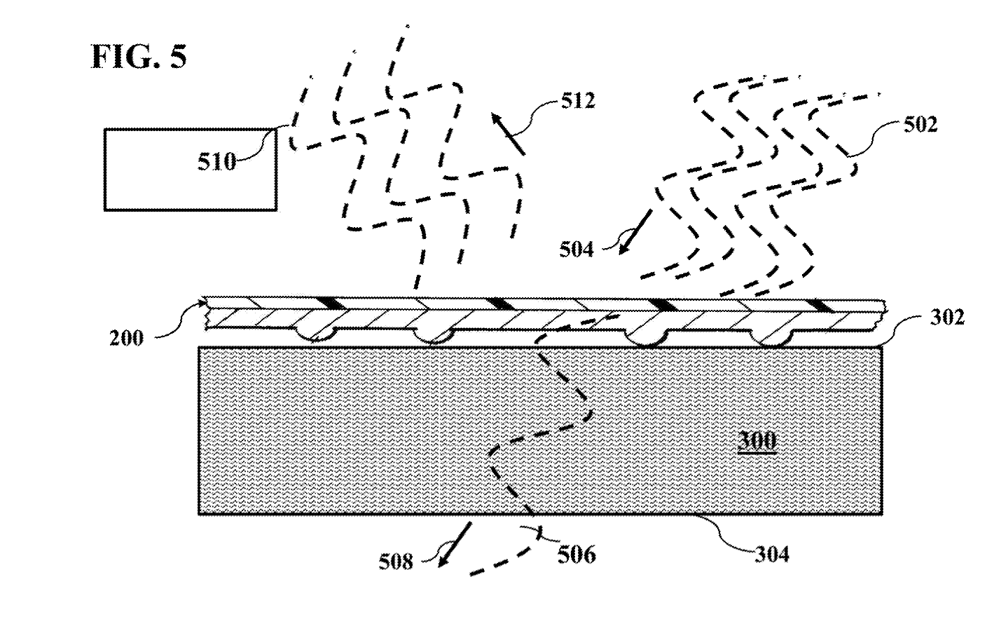

The combination of a metal laminate base sheet with a masonry structure to reduce thermal transfer in accordance with aspects of the present invention will now be described with reference to FIGS. 5-9C.

FIG. 5 illustrates a cross-sectional view of a masonry surface 300 with metal laminate base sheet 200 disposed thereon in accordance with aspects of the present invention.

As shown in the figure, thermal energy 502 is incident on metal laminate base sheet 200. For purposes of discussion, thermal energy 502 is illustrated as approaching metal laminate base sheet 200 in a direction indicated by vector 504. It should be noted that in actuality, thermal energy 502 is contacting metal laminate base sheet 200 from all directions above metal laminate base sheet 200.

Metal laminate base sheet 200 and masonry surface 300 conduct a portion of thermal energy 502 such that portion of thermal energy 506 is transferred through masonry surface 300. For purposes of discussion, portion of thermal energy 506 is illustrated as passing through metal laminate base sheet 200, masonry surface 300 and through interior surface 304 in a direction indicated by vector 508. It should be noted that in actuality, portion of thermal energy 506 is radiating through masonry surface 300 in many directions.

Metal laminate base sheet 200 and masonry surface 300 are able to reflect a portion of thermal enemy 502 such that a portion of thermal energy 519 is reflected off metal laminate base sheet 200. For purposes of discussion, portion of thermal energy 510 is illustrated as reflecting from metal laminate base sheet 200 in a direction indicated by vector 512. It should be noted that in actuality, portion of thermal energy 510 is radiating away from metal laminate base sheet 200 in many directions.

By comparing masonry surface 300 alone, as describe above with reference FIG. 3, with the combination of metal laminate base sheet 200 and masonry surface 300 in accordance with aspects of the present invention as shown in FIG. 5, it is clear that to portion of thermal enemy 310 of FIG. 3, is much greater than portion of thermal energy 596 of FIG. 5, This is a direct result of the reflected portion of thermal energy 314 of FIG. 3, is much lower than the reflected portion of thermal energy 510 of FIG. 5

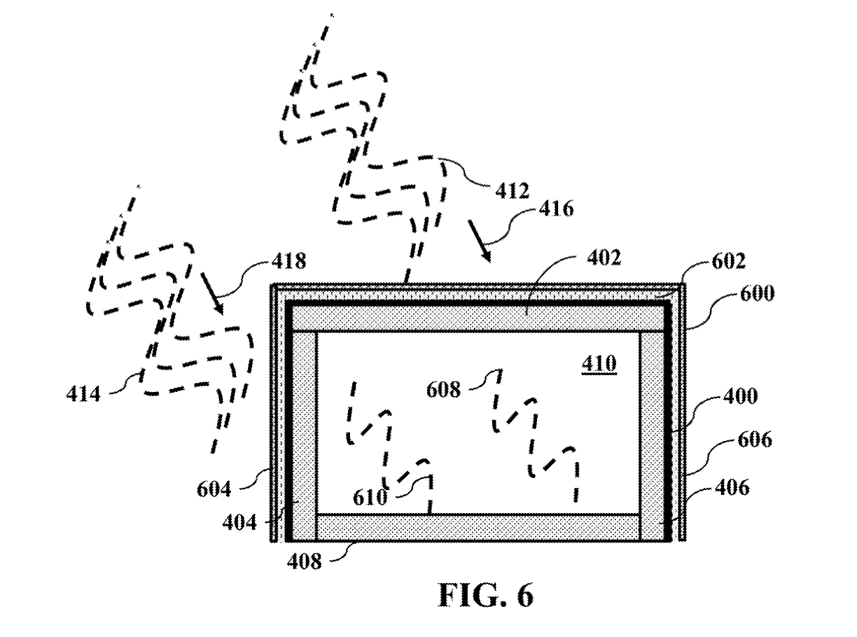

Because of the amount of thermal energy that conducts through masonry surface 300 in the metal laminate base sheet 200 and masonry surface 309 combination as discussed with reference to FIG. 5, for example that represented by portion of thermal energy 506, a masonry structure heats up much less. This will be described in greater detail with reference to FIG. 6.

FIG. 6 illustrates a cross-sectional view of a masonry building 600, which includes masonry building 400 with a base sheet disposed thereon in accordance with aspects of the present invention.

As shown in the figure, masonry building 600 includes masonry building 400 discussed above in addition to a metal laminate base sheet 602, a metal mesh 604 and a stucco coating 606. This simple rectangular structure is shown merely for purposes of discussion, it should be noted that any masonry structure may be used in accordance with aspects of the present invention. Further, it should be noted that doors and windows, and other egresses, may be included in a masonry structure, but are not included in this discussion as they do not pertain to aspects of the present invention.

Metal laminate base sheet 602 is disposed on masonry building 400. Metal mesh 604 is disposed on metal laminate base sheet 602. Stucco coating 606 is disposed onto and around metal mesh 604 so as to coat metal laminate base sheet 602. It should be noted that metal mesh 604 and stucco coating 606 are optional layers.

Similar to the discussion above with reference to FIG. 5, in the case of masonry building 600, thermal energy 412 is incident on stucco coating 606, which is in contact with metal mesh 604, which is in contact with metal laminate base sheet 602, which is in contact with masonry roof 402. Similarly, thermal energy 414 is incident on stucco coating 606, which is in contact with metal mesh 604, which is in contact with metal laminate base sheet 602, which is in contact with masonry side 404. For purposes of discussion, thermal energy 412 is illustrated as approaching stucco coating 606 in a direction indicated by vector 416 and thermal energy 414 is illustrated as approaching stucco coating 606 in a direction indicated by vector 418. It should be noted that in actuality, thermal energy 412 is the roof portion of stucco coating 606 from all directions above roof portion of stucco coating 606 and thermal energy 414 is a side of stucco coating 606 from all directions to the left of the side of stucco coating 606.

In accordance with aspects of the present invention, the addition of a metal laminate base sheet, for example those described with reference to FIGS. 2-3, is used on masonry surface. In this manner, the metal laminate base sheet acts as a thermal reflector to reduce heat transfer through masonry surface. By comparing masonry structure 400 as shown in FIG. 4 with masonry structure 600 shown in FIG. 6, it is clear that a decreased amount of thermal energy conducts through the metal laminate base sheet 200 and through masonry surface 300.

Thermal energy transfer was tested on a five-inch thick concrete block building in the daytime. A bare concrete block building resulting in a detected external temperature of 105° F. and an internal temperature 99° F. However, by covering the concrete block building with a metal laminate base sheet in accordance with aspects of the present invention and measuring under similar conditions, the detected external temperature was 98° F. and the detected internal temperature was 2° F. That is a 17° F. difference in the internal temperature.

As mentioned previously, the decrease in conducted thermal energy leads to a decrease in internal temperature, and a decrease in sweating of interior masonry surfaces. The decrease in sweating of the interior masonry surfaces leads to a decrease of humidity of the air within the inner volume of the masonry structure, which leads to more comfort.

In accordance with another aspect of the present invention, the metal laminate base sheet may include a first marker for residential deployment and a second marker for commercial deployment. As such, a single sheet of material may be manufactured, sold and used for either residential or commercial use.

In particular, a metal laminate base sheet may have dual-use printed deployment markings printed thereon. For example, residential building codes may provide for a first predetermined amount of overlay for metal laminate base sheet material, e.g., 1 inch. As such, residential building sheet materials may include a residential deployment marking printed thereon, e.g., a colored line disposed 1 inch from the border, to assist. an installer for overlaying on residential building. On the other hand, commercial building sheet materials may include a commercial deployment marking printed thereon, e.g., a colored line disposed 4 inches from the border, to assist an installer for overlaying on commercial buildings.

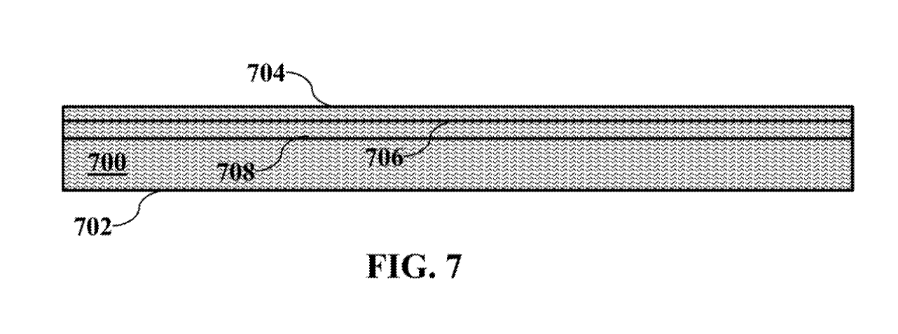

A duel-marked metal laminate base sheet in accordance with aspects of the present invention will now be described with reference to FIGS. 7-9C.

FIG. 7 illustrates a dual-marked metal laminate base sheet 700 in accordance with aspects of the present invention.

As shown in the figure, dual-marked metal laminate base sheet 700 has a bottom edge 702, a top edge 704, a primary alignment line 706 and a secondary alignment line 708.

In a non-limiting example embodiment, primary alignment line 706 corresponds to a residential deployment whereas secondary alignment line 708 corresponds to a commercial deployment.

When deploying sheets of a dual-marked metal laminate base sheet in accordance with aspects of the present invention, one dual-marked metal laminate base sheet is disposed so as to partially cover a previously disposed dual-marked metal laminate base sheet such that the bottom edge of the dual-marked metal laminate base sheet covers the previously disposed dual-marked metal laminate base sheet down to one of the alignment lines. In this manner, a single type of laminate base sheet may have dual uses.

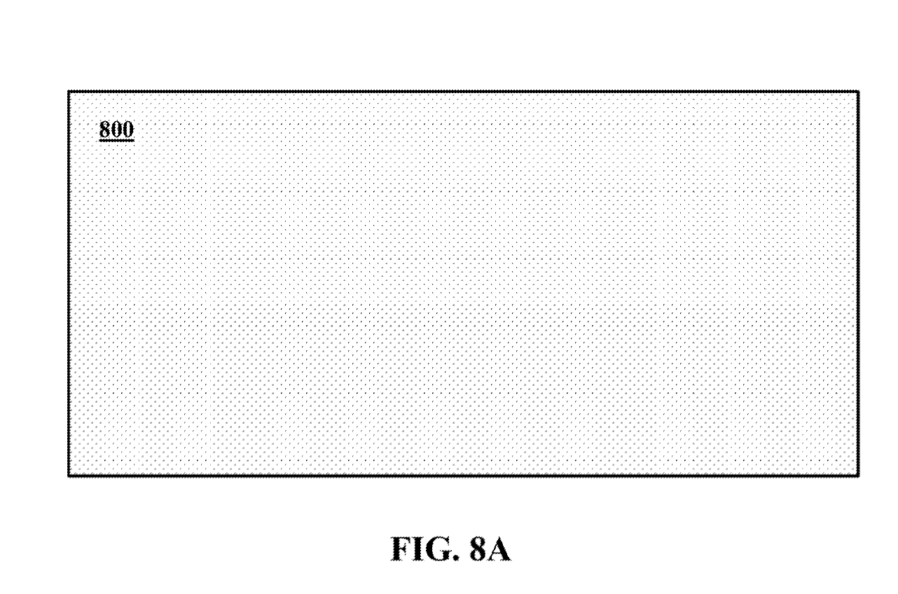

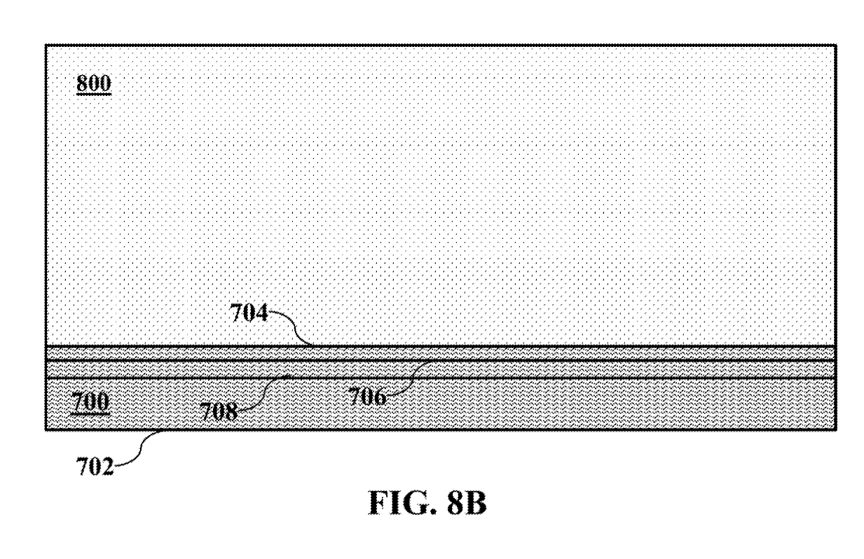

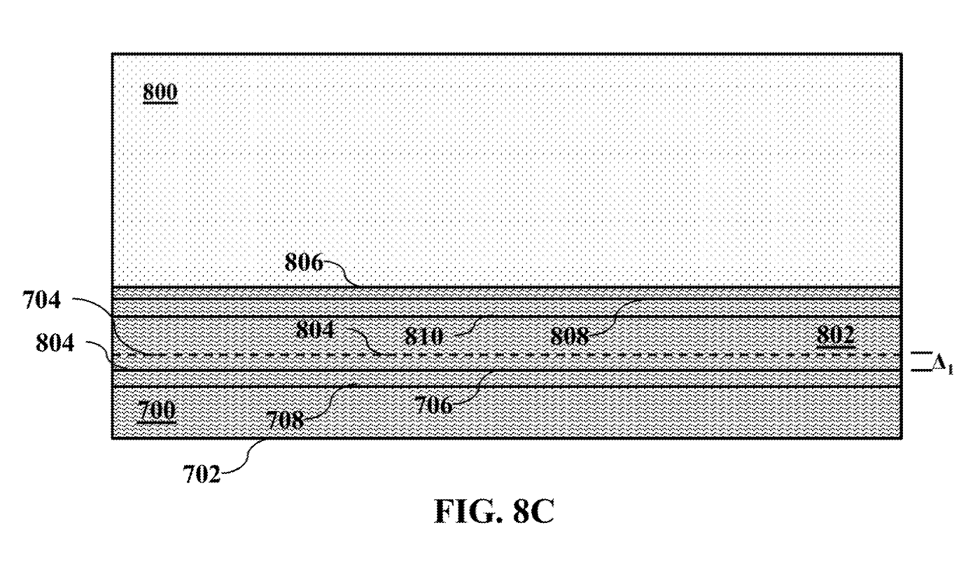

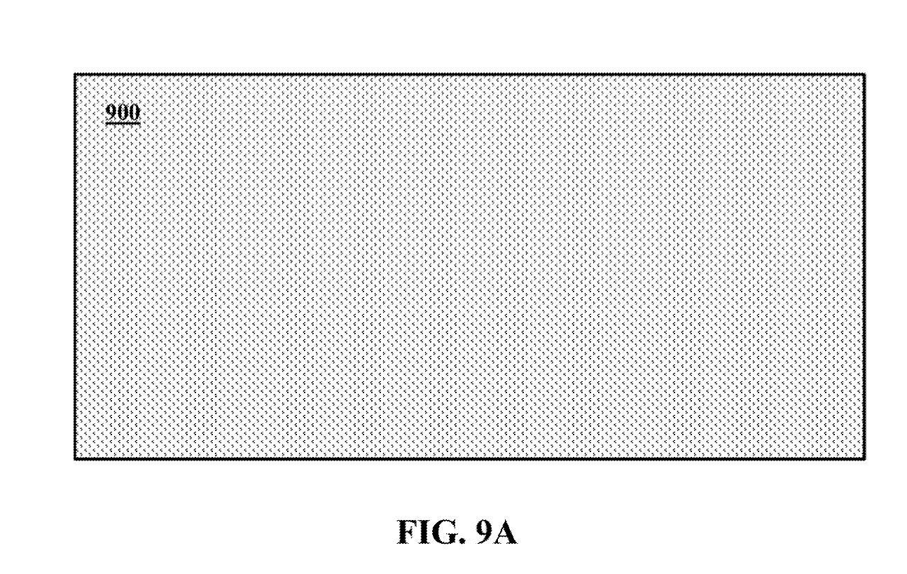

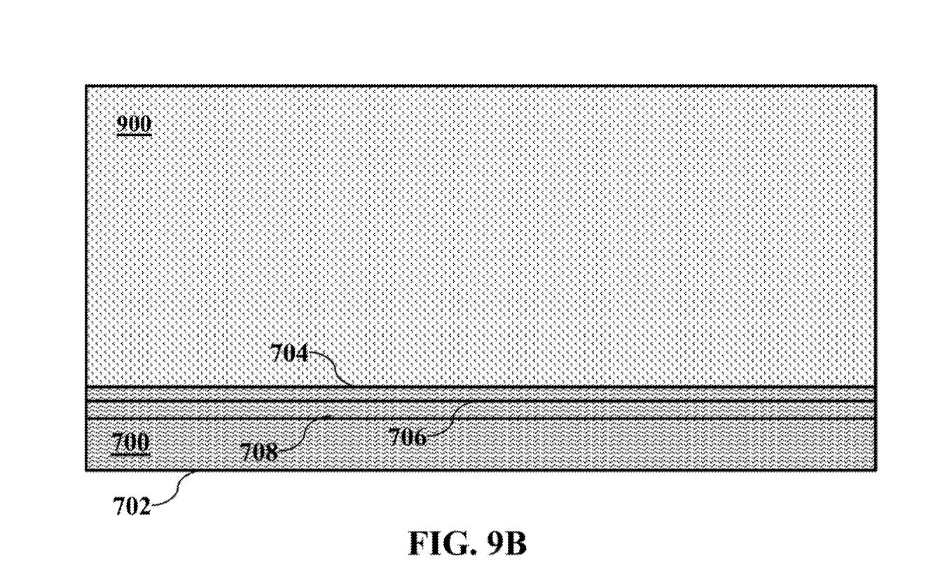

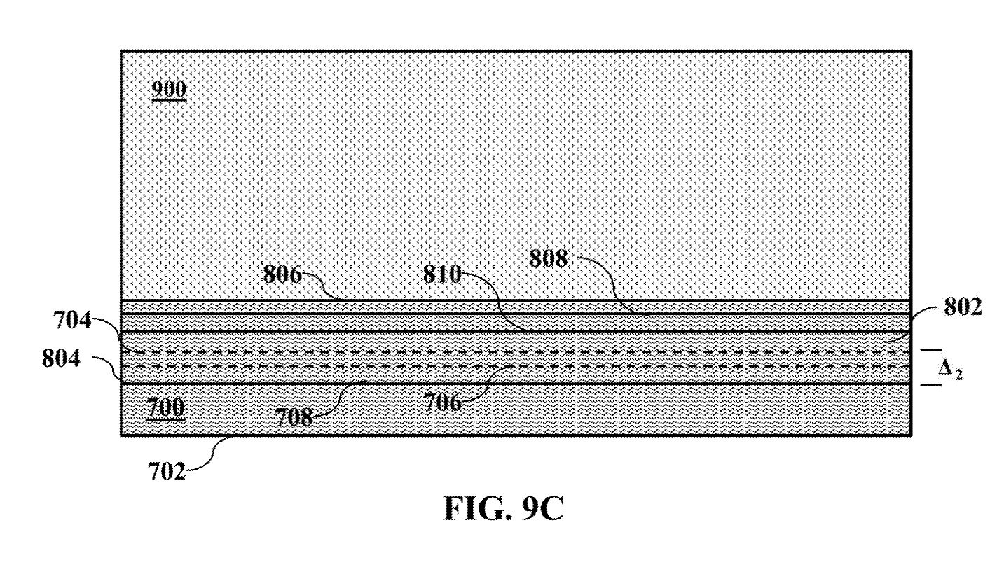

Different uses of dual-marked metal laminate base sheet 700 will now be described with reference to FIGS. 8A-9C.

FIGS. 8A-8C illustrate a primary use of dual-marked metal laminate base sheet 700.

FIG. 8A illustrates a masonry surface 800 of a residential building.

FIG. 8B illustrates masonry surface 800, with metal laminate base sheet 700 disposed thereon in accordance with aspects of the present invention. As shown in the figure, metal laminate base sheet 700 is disposed such that bottom edge 702 runs along the bottom edge of masonry surface 800.

FIG. 8C illustrates masonry surface 800 as shown in FIG. 8B with a metal laminate base sheet 802 additionally disposed thereon in accordance with aspects of the present invention. As shown in the figure, metal laminate base sheet 802 is disposed so as to partially cover metal laminate base sheet 700. In particular, bottom edge 804 of metal laminate base sheet 802 is aligned along primary alignment line 706 such that metal laminate base sheet 802 overlaps metal laminate base sheet 700 by a spacing Δ₁. Primary alignment line 706 therefore acts as a guide to prevent inadvertent, and unwanted, spacing between metal laminate base sheet 700 and metal laminate base sheet 802 when being installed.

Many municipalities may have constructions codes for underlayment materials in construction of residential houses. Primary alignment line 706 may easily enable an installer to conform to such construction codes. Further, many municipalities may have a different set constructions codes for underlayment materials in construction of commercial buildings. Secondary alignment line 706 may easily enable an installer to conform to such construction codes. This will be described with reference to FIGS. 9A-C.

FIGS. 9A-9C illustrate a secondary use of dual-marked metal laminate base sheet 700.

FIG. 9A illustrates a masonry surface 900 of a commercial building.

FIG. 9B illustrates masonry surface 900, with metal laminate base sheet 700 disposed thereon in accordance with aspects of the present invention. As shown in the figure, metal laminate base sheet 700 is disposed such that bottom edge 702 runs along the bottom edge of masonry surface 900.

FIG. 9C illustrates masonry surface 900 as shown in FIG. 9B, with metal laminate base sheet 802 additionally disposed thereon in accordance with aspects of the present invention. Similar with the residential implementation discussed above with reference to FIG. 8C, here in the commercial implementation, metal laminate base sheet 802 is disposed so as to partially cover metal laminate base sheet 700. However, in contrast with the residential implementation discussed above with reference to FIG. 8C, here in the commercial implementation, bottom edge 804 of metal laminate base sheet 802 is aligned along secondary alignment line 708 such that metal laminate base sheet 802 overlaps metal laminate base sheet 700 by a spacing Δ₂, wherein Δ₂>Δ₁. Secondary alignment line 708 therefore acts as a guide to prevent inadvertent, and unwanted, spacing between metal laminate base sheet 700 and metal laminate base sheet 802 when being installed.

It should be noted that the above-identified non-limiting example embodiments of the present invention include the use of a metal laminate base sheet in conjunction with a masonry surface. However, aspects of the present invention may additionally be used under shingles, metal roofs and tile.

Conventionally, metal laminate base sheets have been used in wooden built-up roofs to prevent bitumen entering the underlying building and fueling a fire. Additionally, the metal layer was used as a barrier for preventing any bitumen (or other material) applied during installation from penetrating the deck and into the interior of the underlying building.

In accordance with aspects of the present invention, a metal laminate base sheet is used in conjunction with a masonry layer to decrease thermal energy transfer into a masonry building. An added benefit to the conjunction of a metal laminate base sheet and a masonry layer includes decreasing an amount of humidity within a masonry building.

In the drawings and specification, there have been disclosed embodiments of the invention and, although specific terms are employed, they are used in a generic and descriptive sense only and not for purposes of limitation, the scope of the invention being set forth in the following claims.

What is claimed as new and desired to be protected by Letters Patent of the United States is:

1. A structure comprising:
a masonry layer; and
a laminate of a metal layer and a fabric overlying said masonry layer such that said metal layer faces said masonry layer.

2. The structure of claim 1, wherein said metal layer has embossments thereon forming venting channels.

3. The structure of claim 2, wherein said metal layer comprises aluminum.

4. The structure of claim 3, wherein said fabric comprises non-woven polyester.

5. The structure of claim 1. wherein said metal layer comprises aluminum.

6. The structure of claim 5, wherein said fabric comprises non-woven polyester.

7. The structure of claim I, wherein said fabric comprises non-woven polyester.

8. A method of building a structure comprising:
installing a masonry layer; and
overlying a laminate of a metal layer and a fabric onto the masonry layer such that the metal layer faces the masonry layer.

9. The method of claim 8, wherein said overlying a laminate of a metal layer and a fabric onto the masonry layer comprises overlying the laminate of the metal layer having embossments thereon forming venting channels.

10. The method of claim 9, wherein said overlying a laminate of a metal layer and a fabric onto the masonry layer comprises overlying a laminate of aluminum.

11. The method of claim 10, wherein said overlying a laminate of a metal layer and a fabric onto the masonry layer comprises overlying the laminate of the metal and a non-woven polyester.

12. The method of claim 8, wherein said overlying a laminate of a metal layer and a fabric onto the masonry layer comprises overlying a laminate of aluminum.

13. The method of claim 12, wherein said overlying a laminate of a metal layer and a fabric onto the masonry layer comprises overlying the laminate of the metal and a non-woven polyester.

14. The method of claim 8, wherein said overlying a laminate of a metal layer and a fabric onto the masonry layer comprises overlying the laminate of the metal and a non-woven polyester.
